(19) United States
(12) Patent Application Publication
(10) Pub. No.: US 2023/0153714 A1
(43) Pub. Date: May 18, 2023

(54) ACCESS AND MANAGEMENT FOR REMOTE EMPLOYEES

(71) Applicant: 3MD, Inc., Redmond, WA (US)

(72) Inventors: Clayton Daffron, Vancouver, WA (US); Nicholas Garner, Sunnyvale, CA (US)

(21) Appl. No.: 17/970,426

(22) Filed: Oct. 20, 2022

Related U.S. Application Data
(60) Provisional application No. 63/257,967, filed on Oct. 20, 2021.

(51) Int. Cl. G06Q 10/0631; H04L 43/062; H04L 43/067; H04L 43/026

(52) U.S. Cl. CPC G06Q 10/063114; H04L 43/062; H04L 43/067; H04L 43/026

(57) ABSTRACT

Technologies and implementations for facilitating and management of communication between a home network and an enterprise network for an employee working remote from a business. The management may include prioritizing data traffic between home related activities and/or business related activities, based at least in part, on detected activities. The management may include determining which devices are home devices and business devices utilizing the home network and/or the enterprise network. The management may include ease of communication setup between the home network and the enterprise network. The management and implementations may include facilitating remote Information Technology (IT) support for the employee from the business.

### RELATED APPLICATION

This application claims benefit of priority to U.S. Provisional Patent Application Ser. No. 63/257,967, filed on Oct. 20, 2021, titled ACCESS AND MANAGEMENT FOR REMOTE EMPLOYEES, which is incorporated herein by reference in its entirety for all purposes.

### INFORMATION

Unless otherwise indicated herein, the approaches described in this section are not prior art to the claims in this application and are not admitted to be prior art by inclusion in this section.

More and more people may be working remotely. Recent health related issues, such as a pandemic related to the novel corona virus (COVID-19), may have advanced more people to work remotely. As more people work remotely (e.g., an employee working outside a business), working remotely may be considered to be a business model, which many businesses may be adopting for various reasons. Some of these reasons may include, but not limited to, improved overhead costs for the overhead costs for the business, employee flexibility, employee satisfaction, improved productivity for the employee and/or the business.

As more employees work remotely, a challenge for the business may be in supporting the employees. For example, information technology (IT) support for the remote employee may be challenging due to the employee not being located or working within the business's network (e.g., enterprise network). Supporting a couple of remote employees may be feasible, but as the number of remote employees increases, supporting the increasing number of remote employees may be challenging for the business. Commonly, the employee may utilize a private network (e.g., home network) to gain access to the enterprise network. Use of the home network to gain access to the enterprise network may include security issues as well.

Additionally, home networks may not be optimized for enterprise networking. For example, residential internet service providers (ISPs) may not be optimized for enterprise related network traffic such, as but not limited to, video conferencing, applications related to large team collaboration (e.g., workflow), large database management, calculation intensive applications (e.g., large spreadsheets), etc. Accordingly, employees working remotely may negatively affect the ability of the employees to collaborate and/or innovate for the business.

Another challenge for the business may be related to management of business equipment. For example, the remote employee may utilize their own equipment to work remotely. Here again, the network security and/or information security may be an issue.

Work-from-home may have become mainstream since March 2020. COVID-19 promoted technology's role at the heart of transformation. Close to 30 percent of organizations see it as an opportunity to transform. This may be the New Normal even beyond COVID-19.

All subject matter discussed in this section of this document is not necessarily prior art and may not be presumed to be prior art simply because it is presented in this section. Plus, any reference to any prior art in this description is not and should not be taken as an acknowledgement or any form of suggestion that such prior art forms parts of the common general knowledge in any art in any country. Along these lines, any recognition of problems in the prior art are discussed in this section or associated with such subject matter should not be treated as prior art, unless expressly stated to be prior art. Rather, the discussion of any subject matter in this section should be treated as part of the approach taken towards the particular problem by the inventor(s). This approach in and of itself may also be inventive. Accordingly, the foregoing summary is illustrative only and not intended to be in any way limiting. In addition to the illustrative aspects, embodiments, and features described above, further aspects, embodiments, and features will become apparent by reference to the drawings and the following detailed description.

### SUMMARY

Described herein are various illustrative methods, systems, and apparatus for facilitating remote access and management for remote employees. Some example methods include seamlessly prioritizing enterprise related network traffic within a home network. Some other example methods includes management of business and non-business related equipment utilizing the home network. Some other example methods may include facilitating setting up of communication between the home network and the enterprise network utilizing device readable image. The device readable image may include a quick response (QR) code.

Some example systems include a processor, a storage medium, and a remote office access module. In an example, the remote office access module may be configured to facilitate communication between a home network and an enterprise network. In another example, the remote office access module may be configured to manage network data traffic based, at least in part, on data traffic related to home network activity and/or data traffic related to enterprise network activity. In yet another example, the remote office access module may be configured to seamlessly utilize the home network and a cellular base network based, at least in part, on data traffic related to home network activity and/or data traffic related to enterprise network activity. In yet another example, the remote office access module may be configured to manage business and non-business related equipment utilizing the enterprise network.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a system for facilitating remote configuration and working in accordance with various embodiments.

FIG. 2 illustrates an example of setting up of a remote access device in accordance with various embodiments.

FIG. 3 illustrates an operational flow for facilitating remote access and management of remote employees in accordance with various embodiments as described herein.

FIG. 4 illustrates an example computer program product, arranged in accordance with at least some embodiments described herein.

FIG. 5 is a block diagram illustrating an example computing device 500, such as might be embodied by a person skilled in the art, which is arranged in accordance with at least some embodiments of the present disclosure.

### DETAILED DESCRIPTION

The following description sets forth various examples along with specific details to provide a thorough understanding of claimed subject matter. It will be understood by those skilled in the art after review and understanding of the present disclosure, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, systems, and apparatus for facilitating remote access and management of remote employees.

Some non-limiting example scenarios illustrating the utilization and implementation of the various embodiments of the present disclosure may be described. In a non-limiting scenario, a business may have one or more employees. The business may have an enterprise network that may be utilized within the business and its organization. An employee of the business may have arranged to work remotely (e.g., from their residence or home). The employee may have a home network, which may be serviced by a residential internet service provider (ISP). Additionally, the residence of the employee may be covered by a cellular communication network (e.g., 2G, 3G, LTE, 5G, 6G, CDMA, Edge, etc.).

In the non-limiting scenario, a router and/or modem may be configured to provide a wireless edge solution (hereon, “router”). The router may include a communication management module (hereon, “communication module”). The router may be provided to the employee. The employee may place the router in their home, where the employee may plan to work. The employee may turn on the router and communicatively couple the route to the home network (e.g., home Wi-Fi and/or cabled network). The router may include a device readable image such as, but not limited to, a QR code.

Once turned on and connected, the employee may scan the QR code utilizing a computing device such as, but not limited to, a handheld computing device. The QR code may be configured to help facilitate communication coupling of the home network with the business network (hereon, “enterprise network”). The communication coupling may be configured to be under the management of the communication module, where the communication module may be configured to facilitate management of communication between the home network and the enterprise network (i.e., devices that the employee may utilized to access the enterprise network to perform their work responsibilities remotely/remote office access module).

Once the communication coupling between the home network and the enterprise network is established, the employee may utilize a computing device (e.g., a personal computer, which was purchased for personal related use by the employee and/or a business computer provide by the business for business related use). As a result, the employee may be provided with the ability to work on the enterprise network from home (i.e., work from home).

In one example, the communication module may be configured to determine types of data traffic on the network (i.e., data being communicated between the home network and the enterprise network). For example, the communication module may be configured to determine data traffic that may be considered to be business related such as, but not limited to, business related email, business related video conferencing, business related PowerPoint presentations, business related spreadsheet calculations, and so forth. Additionally, the communication module may be configured to determine data traffic that may be considered to be of a personal nature such as, but not limited to, game related data traffic (e.g., a gaming console on the home network), video and/or music related data traffic, social networking related data traffic, personal email related data traffic, and so forth.

Continuing with the example of the communication module configured to determine the types of data traffic, the communication module may be configured to prioritize data traffic based, at least in part, on the determined type of data traffic on the network. For example, if the communication module determines that the data capacity of the home network may be approaching potential bandwidth issues, the communication module may utilize a different communication approach than the home network. The different communication approach may be a cellular based communication network such as, but not limited to, long-term evolution (LTE), 5G, 6G, CDMA, Edge, and so forth. Accordingly, the communication module may prioritize the business related data traffic by diverting some business related data traffic to the cellular based communication network to help reduce bandwidth issues with the business related data traffic. The prioritization of the data traffic may help facilitate uninterrupted and/or reduce degradation of the business related data traffic. As part of the prioritization example, if the demand on the home network data traffic reduces at some point (e.g., the gaming console goes off line, video and/or music streaming has reduced, and so forth), the communication module may be configured to return the business related data traffic to the home network. As a result, the employee working from home may experience an improved working from home experience with reduced bandwidth issues with business related data traffic.

In another example, the communication module may be configured to determine the types of devices on the home network. For example, the communication module may be configured to determine if the devices on the home network may be personal or business related. As part of the determination, the communication module may be configured to determine which of the personal and/or business devices detected on the home network may be communicatively coupled with the enterprise network (e.g., the employee may be utilizing their own personal equipment such as, but not limited to, a personal computing device). The communication module may be configured to communicate the device related information to the business facilitating addressing of potential security issues of having a personal computing device communicatively coupled with the enterprise network.

In yet another example, the communication module may be configured to help facilitate providing information technology (IT) support from the business. For example, if the employee has potential technical issues with their work, the communication module may be configured to communicate the potential technical issues to the business. The business may have the ability to potentially address the potential technical issues via the communication module included in the router. For example, the employee may be having issues accessing a file and/or folder on the enterprise network. The potential technical issue may be related to a setting on the business computing device being used to access the enterprise network. The IT personnel may be provided with the ability to access the business computing device to facilitate addressing the potential technical issue. Accordingly, the communication module may be utilized to provide IT related services by the business. As part of the IT services via the communication module, the business may be provided the ability to provide security and maintain secured communication between the home network and the enterprise network.

In yet another further example, the communication module may be configured to machine learn data traffic management of work related data and non-work related data. For example, the communication module may learn over a period of time (e.g., days, weeks, years, etc.) that the data traffic may be congested during certain periods of time (e.g., evening when people on a shared ISP may tend to stream videos). The communication module may preemptively manage the work related data traffic to other communication mediums (e.g., cellular based communication), where the preemptive management may be based, at least in part, on the learned data traffic patterns.

Some communication methodologies may include internet of things (IoT) related methodologies, which may be utilized alone and/or in conjunction with a communication module to facilitate data traffic management of work related data and/or non-work related data as described herein. Accordingly, for example, wireless communication methodologies that may be utilized may include wireless communication methodologies such as, but not limited to, Wi-Fi, IEEE 802 based, Bluetooth® type, Near Field Communication (NFC), radio-frequency identification (RFID), ad-hoc wireless network solutions (e.g., AirDrop), internet of things (IoT) related communication solutions, mesh local area network (LAN) type (e.g., ZigBee, Bluetooth Low Energy, Z-Wave, 6LoWPAN, Thread, etc.), and any combination thereof.

It should be appreciated by one of ordinary skilled in the relevant art that a wide variety of machine learning methodologies may be employed including communication module having AI capabilities to facilitate at least some of the functionality described herein such as, but not limited to, AI capable processors available from Intel Corporation of Santa Clara, Calif. (e.g., Nervana TM type processors), available from Nvidia Corporation of Santa Clara, Calif. (e.g., Volta TM type processors), available from Apple Company of Cupertino, Calif. (e.g., A11 Bionic TM type processors), available from Huawei Technologies Company of Shenzen, Guangdong, China (e.g., Kirin TM type processors), available from Advanced Micro Devices, Inc. of Sunnyvale, Calif. (e.g., Radeon Instinct TM type processors), available from Samsung of Seoul, South Korea (e.g., Exynos TM type processors), and so forth. Accordingly, the claimed subject matter is not limited in these respects. The utilization of machine learning of data traffic management (i.e., work related data and/or non-work related data) may facilitate less disruption and/or issues with work related data traffic.

The above described components may be configured and reconfigured, in accordance with various embodiments.

Some additional examples may include at least some of the following: cost-effective solution to securely bring a workforce together, whether an employee is distributed or hybrid; may leverage a home network and a cellular network to facilitate an optimized experience; may provide a relatively easy and/or intuitive self-service setup; and may be provided as a Service Consumption Model for predictability and cost optimization.

Some additional examples may include at least some of the further following: a system may be secure access service edge (SASE) ready; may include competitive pricing, reliability, and ease of use; a unification of Wi-Fi, Cellular, and router hardware solutions; may improve a user experience, which may be at an improved relative cost than various alternative offerings; may facilitate an improvement on existing offerings utilizing integrated cellular, may utilize software-defined wide area network (SD-WAN) features, end-user self-service; may facilitate a flexible offering such as, but not limited to, original equipment manufacturer (OEM) options and/or financial consumption models; may facilitate utilization of next generation technology such as, but not limited to, SASE, best-of-breed security offerings, SDWAN, 5G-ready, and/or latest hardware platforms; may provide sophisticated solution, which may provide differentiation and innovation to crowded space; may utilize existing home Wi-Fi network to provide wide range of flexibility; may provide end-user self-service to facilitate utilization of onboard remote office access module (ROAM) endpoint; opportunity for product, managed services, cellular activation and data plans, headend deployment services.

Communication module may be a network-based work from home (WFH)/work remote solution that leverages cellular technology along with the home network to provide a fast, reliable, secure experience to the distributed worker.

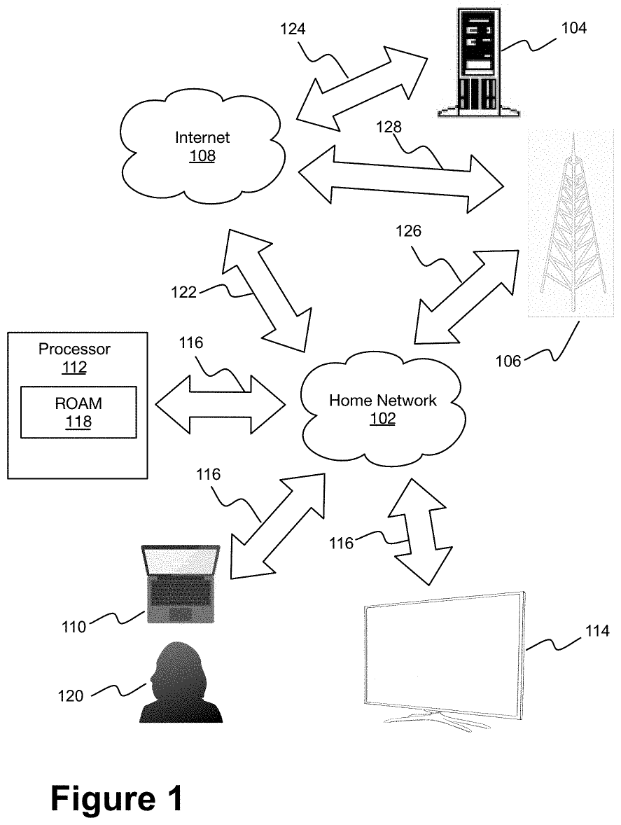

Turning now to FIG. 1, FIG. 1 illustrates a system for facilitating remote configuration and working in accordance with various embodiments. In FIG. 1, a system 100 may include a home network 102, an enterprise network 104, a cellular network 106, and a worldwide network (e.g., Internet 108). As shown, the home network 102 may have a computer (e.g., personal computer or PC 110), a processor 112, and a device, which commonly may be utilized for personal use (e.g., television or TV 114) communicatively coupled to the home network 102 via one or more communication medium 116. The processor 112 may be include in a remote access device in accordance with various embodiments. For example, the processor 112 may include a remote office access module (ROAM 118) in accordance with various embodiments described herein. As shown, the PC 110 may be utilized by a person 120, who may be an employee of an entity and may be working from home utilizing the home network 102. The TV 114 may have smart capabilities such as, but not limited to, smartTV capabilities, which may include video streaming capabilities. The one or more home communication medium 116 may be a wide variety of communication mediums such as, but not limited to, wireless (e.g., Wi-Fi), wired (e.g., utilizing ethernet cable), and/or any combination thereof.

In FIG. 1, the system 100 may include an internet communication medium (e.g., an internet service provider or ISP medium 122). The ISP medium 122 may facilitate communicatively coupling the home network 102 to the Internet 108. In turn, the Internet 108 may be communicatively coupled to the enterprise network 104 via some form of enterprise related internet communication medium (e.g., enterprise ISP 124).

As shown in FIG. 1, the system 100 may include a communication medium between the home network 102 and the cellular network 106 (e.g., a cellular medium 126). The cellular network 106 may be communicatively coupled to the Internet 108 via an internet communication medium (e.g., cellular ISP 128).

As described above with respect to some non-limiting example scenarios, in FIG. 1, the person 120 may be working on their PC 110 remotely (e.g., their home). In order to facilitate working from home, the PC 110 may communicate business related data with the home network 102 via the one or more home communication medium 116. The business related data may be communicated with the Internet 108 via the ISP medium 122. From the Internet 108, the business related data may be communicated with the enterprise network 104 via the enterprise ISP 124.

At some point, the TV 114 may be utilized to stream video, which may affect the data traffic on the home network 102 and/or on the ISP medium 122. ROAM 118 may determine the different types of data traffic on the home network 102. For example, ROAM 118 may be configured to determine which data traffic may be related to business (e.g., data traffic to and from the PC 110) and which data traffic may be related to personal use (e.g., data traffic to and from the TV 114). In the system 100 shown in FIG. 1, ROAM 118 may determine if the data traffic on the home network 102 is at a predetermined level. The predetermined level may be a wide variety of predetermined levels such as, but not limited to, data bandwidth issues that may negatively affect data traffic. For example, data bandwidth issues that may cause data traffic congestion, which may cause slow data traffic, unstable data traffic, dropping of data, truncating of data, and so forth.

If ROAM 118 determines that the data traffic on the home network 102 is at the predetermined level, which may cause data bandwidth issues, ROAM 118 may route the data related to business to the cellular network 106. ROAM 118 may be configured to perform the routing selectively. The business related data traffic may be communicated with the Internet 108 via the cellular ISP 128 from the cellular network 106 facilitating communication of the business related data traffic with the enterprise network 104 via enterprise ISP 124. As a result, negative affects on the business related data traffic may be reduced and/or minimized. Additionally, the routing by ROAM may be substantially seamless, where the person 120 may not notice.

In some examples, ROAM 118 may be configured to determine negative effects on the business related data traffic at the ISP medium 122. For example, the ISP medium 122 may be shared (e.g., neighborhood). As more people in the neighborhood utilizes the ISP medium 122 (e.g., evenings), ROAM 118 may be configured to determine the effects on the data traffic and adjust/route accordingly.

In some examples, even when there may be no data bandwidth issues, ROAM 118 may be configured to prioritize business related data traffic on the home network 102.

It should be appreciated that the communication mediums 116, 122, 124, 126, and 128 may utilize a wide variety of communication methodologies and/or protocols. For example, the communication mediums 116, 122, 124, 126, and 128 may utilize wired and/or wireless methodologies as mentioned herein. Accordingly, the claimed subject matter is not limited in this respect.

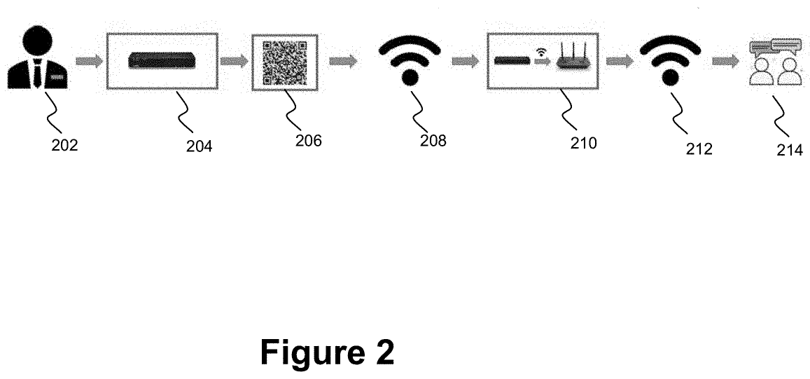

FIG. 2 illustrates an example of setting up of a remote access device in accordance with various embodiments. In FIG. 2, a process of remote access set up 100 may include a person 202, a remote access device 204, a machine readable code 206, a local area network 208, an access to the Internet device 210, an enterprise network 212, and work 214. As shown in FIG. 2, the person 202 (e.g., user/employee) may unbox the remote access device 204 (e.g., ROAM). The person 202 may utilize a personal device such as, but not limited to, a smartphone to scan the machine readable code 206 that may be included with the remote access device 204. The machine readable code 206 may be a wide variety of machine readable code such as, but not limited to, a quick response code, a bar code, etc. The machine readable code 206 may facilitate joining of the local area network 208, where the local area network may be a home network. Additionally, the machine readable code 206 may facilitate a configuration of the Internet device 210. The Internet device 210 may include a router, a modem, and/or any combination thereof. The configured Internet device 210 may facilitate joining of the enterprise network 212 resulting in facilitation of work 214 by the person 202.

In process of remote access set up 100, it should be appreciated that the various components may be interchanged and/or process not being linear. For example, the configuration of the Internet device 210 may be performed from the enterprise network 212. The remote access device 204 may be configured to facilitate an information technology person (IT person) to configure the Internet device 210.

It should be appreciated that the local area network 208 and/or the enterprise network 212 may be wired, wireless, and/or any combination thereof. Accordingly, the claimed subject matter is not limited in this respect.

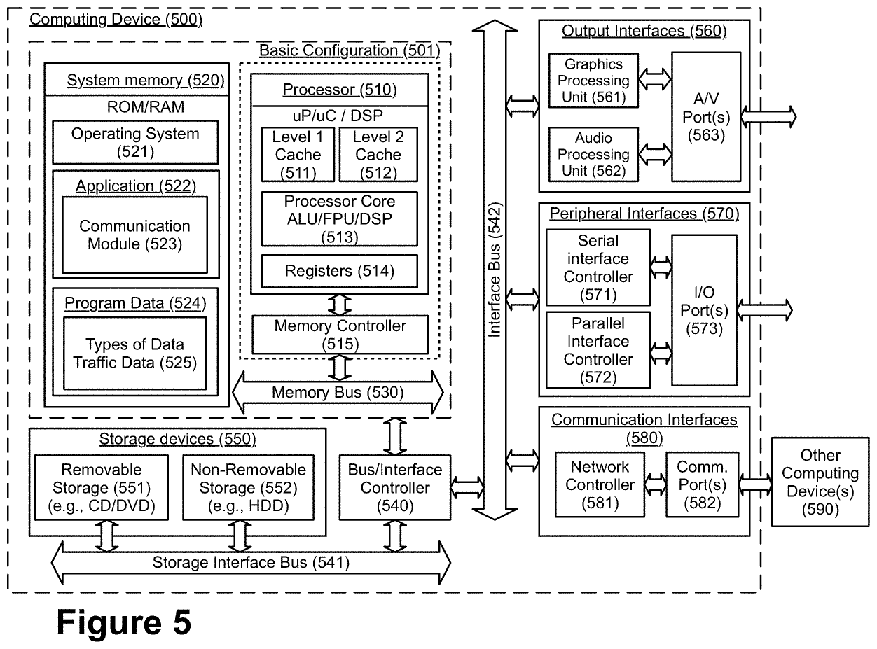

In general, the methods and processes described herein may be implemented in any suitable computing system. Example systems may be described with respect to FIG. 1, FIG. 5, and elsewhere herein. In general, the system may be configured to facilitate remote access and management of remote employees.

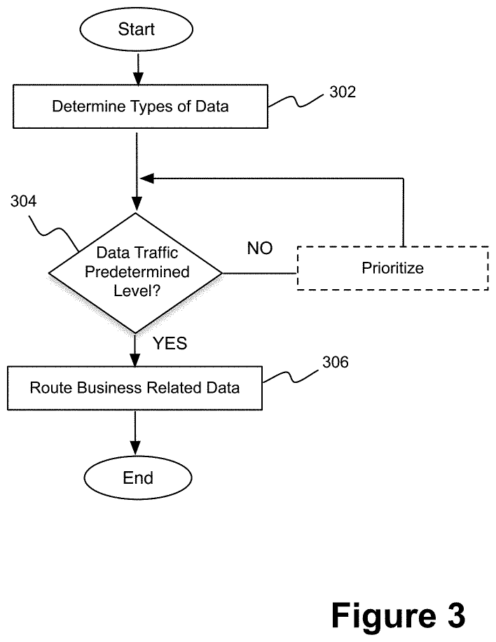

FIG. 3 illustrates an operational flow for facilitating remote access and management of remote employees in accordance with various embodiments as described herein. In some portions of the description, illustrative implementations of the method are described with reference to the elements depicted in FIGS. 1-5. However, the described embodiments are not limited to these depictions.

Additionally, FIG. 3 employs block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In some examples, operational flow 300 may be employed as part of remote access device such as, but not limited to, remote office access module, and so forth as described herein. Beginning at block 302 (“Determine Types of Data”), a remote access device may determine different types of data traffic on a home network, where the different types of data traffic may be a personal related data traffic or a business related data traffic.

Continuing from block 302 to decision diamond 304 (“Data Traffic Predetermined Level?”), the remote access device may determine if the data traffic on the home network is at a predetermined level.

At decision diamond 304, if it is determined that the data traffic on the home network is at a predetermined level, the operational flow may continue from the decision diamond 304 to block 306 (“Route Business Related Data”), where the business related data traffic may be routed to a cellular communication network.

At decision diamond 304, if it is determined that the data traffic on the home network is not at a predetermined level, the operational flow may continue from the decision diamond 304 to continue monitoring. Optionally, the business related data traffic may be prioritized at block 308 (“Prioritize”).

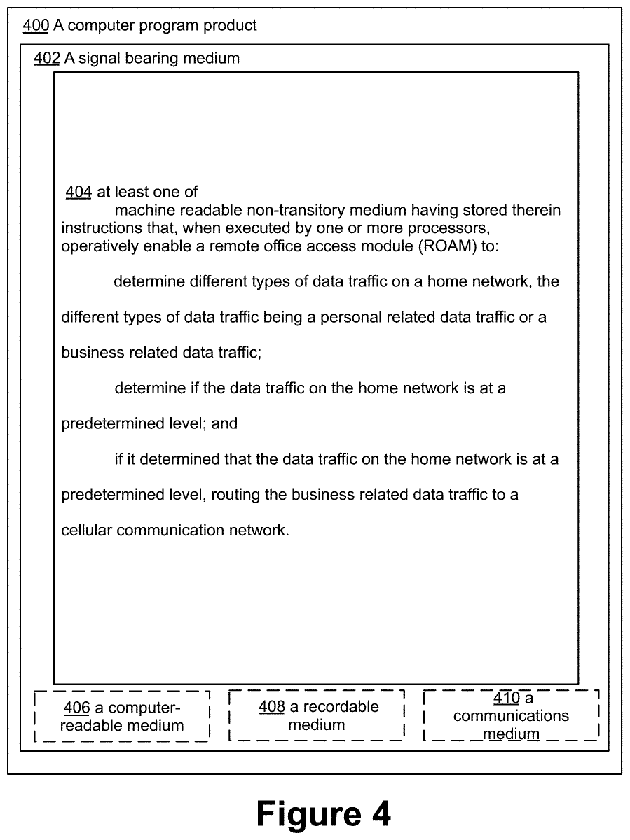

In general, the operational flow described with respect to FIG. 3 and elsewhere herein may be implemented as a computer program product, executable on any suitable computing system, or the like. For example, a computer program product for facilitating remote access and management of remote employees may be provided. Example computer program products may be described with respect to FIG. 4 and elsewhere herein.

FIG. 4 illustrates an example computer program product 400, arranged in accordance with at least some embodiments described herein. Computer program product 400 may include machine readable non-transitory medium having stored therein instructions that, when executed, cause the machine to facilitate remote access and management of remote employees according to the processes and methods discussed herein. Computer program product 400 may include a signal bearing medium 402. Signal bearing medium 402 may include one or more machine-readable instructions 404 which, when executed by one or more processors, may operatively enable a computing device to provide the functionality described herein. In various examples, the devices discussed herein may use some or all of the machine-readable instructions.

In some examples, the machine readable instructions 404 may enable a remote access device to determine different types of data traffic on a home network, where the different types of data traffic may be a personal related data traffic or a business related data traffic. In some examples, the machine readable instructions 404 may facilitate the remote access device to determine if the data traffic on the home network is at a predetermined level. In some examples, the machine readable instructions 404 may facilitate the remote access device to route the business related data traffic to a cellular communication network if it is determined that the data traffic on the home network is at a predetermined level.

In some implementations, signal bearing medium 402 may encompass a computer-readable medium 406, such as, but not limited to, a hard disk drive, a Compact Disc (CD), a Digital Versatile Disk (DVD), a Universal Serial Bus (USB) drive, a digital tape, memory, etc. In some implementations, the signal bearing medium 402 may encompass a recordable medium 408, such as, but not limited to, memory, read/write (R/W) CDs, R/W DVDs, etc. In some implementations, the signal bearing medium 402 may encompass a communications medium 410, such as, but not limited to, a digital and/or an analog communication medium (e.g., a fiber optic cable, a waveguide, a wired communication link, a wireless communication link, etc.). In some examples, the signal bearing medium 402 may encompass a machine readable non-transitory medium.

In general, the methods described with respect to FIG. 4 and elsewhere herein may be implemented in any suitable computing system. Example systems may be described with respect to FIG. 5 and elsewhere herein. In general, the system may be configured to facilitate a remote access in accordance with various embodiments.

FIG. 5 is a block diagram illustrating an example computing device 500, such as might be embodied by a person skilled in the art, which is arranged in accordance with at least some embodiments of the present disclosure. In one example configuration 501, computing device 500 may include one or more processors 510 and system memory 520. A memory bus 530 may be used for communicating between the processor 510 and the system memory 520.

Depending on the desired configuration, processor 510 may be of any type including but not limited to a microprocessor (ρP), a microcontroller (ρC), a digital signal processor (DSP), or any combination thereof. Processor 510 may include one or more levels of caching, such as a level one cache 511 and a level two cache 512, a processor core 513, and registers 514. The processor core 513 may include an arithmetic logic unit (ALU), a floating point unit (FPU), a digital signal processing core (DSP Core), or any combination thereof. A memory controller 515 may also be used with the processor 510, or in some implementations the memory controller 515 may be an internal part of the processor 510.

Depending on the desired configuration, the system memory 520 may be of any type including but not limited to volatile memory (such as RAM), non-volatile memory (such as ROM, flash memory, etc.) or any combination thereof. System memory 520 may include an operating system 521, one or more applications 522, and program data 524. Application 522 may include communication module 523 that is arranged to perform the functions as described herein including the functional blocks and/or actions described. Program Data 524 may include types of data traffic data 525 for use with communication module 523. In some example embodiments, application 522 may be arranged to operate with program data 524 on an operating system 521 such that implementations of facilitating communication module configured to determine the types of data traffic may be provided as described herein. For example, apparatus described in the present disclosure may comprise all or a portion of computing device 500 and be capable of performing all or a portion of application 522 such that implementations of facilitating communication module configured to determine the types of data traffic may be provided as described herein. This described basic configuration is illustrated in FIG. 5 by those components within dashed line 501.

Computing device 500 may have additional features or functionality, and additional interfaces to facilitate communications between the basic configuration 501 and any required devices and interfaces. For example, a bus/interface controller 540 may be used to facilitate communications between the basic configuration 501 and one or more data storage devices 550 via a storage interface bus 541. The data storage devices 550 may be removable storage devices 551, non-removable storage devices 552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable, and non-removable media implemented in any method or technology for storage of information, such as computer readable instructions, data structures, program modules, or other data.

System memory 520, removable storage 551 and non-removable storage 552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of device 500.

Computing device 500 may also include an interface bus 542 for facilitating communication from various interface devices (e.g., output interfaces, peripheral interfaces, and communication interfaces) to the basic configuration 501 via the bus/interface controller 540. Example output interfaces 560 may include a graphics processing unit 561 and an audio processing unit 562, which may be configured to communicate to various external devices such as a display or speakers via one or more A/V ports 563. Example peripheral interfaces 560 may include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication interface 580 includes a network controller 581, which may be arranged to facilitate communications with one or more other computing devices 590 over a network communication via one or more communication ports 582. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 500 may also be implemented as a personal computer including both laptop computer and non-laptop computer configurations. In addition, computing device 500 may be implemented as part of a wireless base station or other wireless system or device.

It should be appreciated after review of this disclosure that it is contemplated within the scope and spirit of the present disclosure that the claimed subject matter may include a wide variety of routers, modems, computing devices, communication mediums/approaches, etc. Accordingly, the claimed subject matter is not limited in these respects.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

1. An apparatus for remote working, the apparatus comprising:
a processor;
a communication device communicatively coupled with the processor;
a remote office access module (ROAM) communicatively coupled to the processor, the ROAM configured to:
determine different types of data traffic on a home network, the different types of data traffic being a personal related data traffic or a business related data traffic;
determine if the data traffic on the home network is at a predetermined level; and
if it is determined that the data traffic on the home network is at a predetermined level, route the business related data traffic to a cellular communication network via the communication device.

2. The apparatus of claim 1, wherein the communication device comprises a wireless communication device.

3. The apparatus of claim 2, wherein the wireless communication device comprises a Wi-Fi communication device.

4. The apparatus of claim 2, wherein the wireless communication device comprises a cellular communication device.

5. The apparatus of claim 1, wherein the ROAM is further configured to maintain the personal related data traffic on the home network.

6. The apparatus of claim 1, wherein the ROAM is further configured to maintain both the personal related data and the business related data on the home network.

7. The apparatus of claim 1, wherein the ROAM is further configured to prioritize the business related data on the home network.

8. A method for facilitating remote working comprising:
determining different types of data traffic on a home network, the different types of data traffic being a personal related data traffic or a business related data traffic;
determining if the data traffic on the home network is at a predetermined level; and
if it is determined that the data traffic on the home network is at a predetermined level, routing the business related data traffic to a cellular communication network.

9. The method of claim 8 further comprising maintaining both the personal related data traffic and the business related data traffic on the home network if it is determined that the data traffic on the home network is not at a predetermined level.

10. The method of claim 8 further comprising prioritizing the business related data traffic over the personal related data traffic on the home network.

11. A method for facilitating remote working comprising:
determining different types of data traffic on a home network, the different types of data traffic being a personal related data traffic or a business related data traffic;
determining if the data traffic on the home network is at a predetermined level;
if it is determined that the data traffic on the home network is at a predetermined level, time stamping when the data traffic on the home network is determined to be a predetermined level;
storing the time stamp;
storing a plurality of subsequent time stamps;
determining a pattern of when the data traffic on the home network is at a predetermined level based, at least in part, on the stored plurality of subsequent time stamps. the business related data traffic to a cellular communication network; and
routing the business related data traffic to a cellular communication network based, at least in part, on the determined pattern.

12. (canceled)

13. (canceled)

14. (canceled)
